(19) United States
(12) Patent Application Publication
(10) Pub. No.: US 2004/0263600 A1
(43) Pub. Date: Dec. 30, 2004

(54) Ink jet recording apparatus

(75) Inventor: Yoshihide Hoshino, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA MEDICAL & GRAPHIC, INC.

(21) Appl. No.: 10/870,954

(22) Filed: Jun. 21, 2004

(30) Foreign Application Priority Data
Jun. 25, 2003 (JP) JP2003-181401

(51) Int. Cl. B41J 2/01

(52) U.S. Cl. 347/102

(57) ABSTRACT

An ink jet recording apparatus including, a recording head for jetting ink droplets onto a recording medium, a light radiating device for radiating light rays to harden the ink droplets adhered onto the recording medium, a heating device for emitting heat to heat the recording medium, an environment detecting device for detecting at least any one of environmental temperature or environmental humidity, and a control section for controlling an amount of heat emitted from the heating device, based on a detected result of the environment detecting device.

### BACKGROUND OF THE INVENTION

The present invention relates to an ink jet recording apparatus, and in particular, to an ink jet recording apparatus wherein images are recorded in such a way that ink is hardened by light radiation.

In recent years, a great number of image recording apparatuses using ink jet recording methods have been utilized. Because ink jet recording methods can form images very conveniently and at low cost, compared to methods in which a plate-making is required, such as photogravure printing and flexographic printing.

Further, ink jet printing methods are often used in the field where images are recorded on commercial products or on their packaging materials, such as resin and metal, having no ink absorbing property. In order to permanently fix ink drops on a recording medium sheet having no ink absorbing property, image-setting ink is used. Namely, well known is an image recording apparatus using such image-setting ink, wherein after the image-setting ink drops are jetted onto the recording medium sheet, light rays, such as ultraviolet light, are radiated so that the ink drops are hardened and fixed. (see Patent Document 1)

Patent Document 1: Japanese Tokkai 2001-310454

However, image-setting ink has the nature that the degree of ink hardening varies widely due to environmental conditions, therefore, in conventional ink jet recording apparatuses (Patent Document 1), ink is not successfully hardened under unusual environments, and it is not possible to obtain uniform and successful images, which is a major problem. Specifically when ultraviolet hardening ink of cation polymerization system is used, ink hardening reaction is apt to depend upon ambient humidity and temperature, due to the nature of polymerization reaction, and characteristically, the images are scarcely hardened so that the images are very poor in quality, especially under high humidity or low temperature conditions.

### SUMMARY OF THE INVENTION

Therefore, the objective of the present invention is to provide an ink jet recording apparatus which is able to produce uniform and practical images, independent of environmental conditions, by keeping recording medium in a condition suitable for recording practical images. The objective mentioned above is attained by structures described below.

Structure 1

An ink jet recording apparatus, including:

a recording head which jets ink which is to be hardened by light radiation; and

a light radiating device which radiates light rays to harden the ink;

while conveying a recording medium in a specific direction, ink is jetted from the recording head onto the recording medium, and the ink is hardened by using radiated light rays from the light radiating device,

wherein provided are

a heating device for heating the recording medium,

a control section for controlling the heat value generated by the heating device, and

an environment detecting device which detects at least either environmental temperature or humidity, and wherein the control section controls the heat value generated by the heating device, based on the results detected by the environment detecting device.

According to structure 1, since the recording medium is heated by the heating device with the heat value which is controlled based on at least the environmental temperature or humidity, created is the condition under which the assured images can be recorded onto the recording medium, independent of the environmental conditions.

Structure 2

The ink jet recording apparatus of structure 1, wherein the environment detecting device detects environmental humidity,

the control section starts the heating by the heating device, when the detected result of the environment detecting device surpasses a threshold level.

According to structure 2, when the detected result by the environment detecting device surpasses the threshold level, the recording medium is heated by the heating device, and thereby the recording medium is dried which had been humidified by the environmental humidity, that is, created is the condition under which the assured images can be recorded onto the recording medium, independent of the environmental humidity.

Structure 3

The ink jet recording apparatus of structure 1 or 2, wherein the environment detecting device detects the environmental humidity, and the higher the humidity detected by the environment detecting device, the higher the control section sets the heat value to be generated by the heating device.

According to structure 3, the recording medium is heated by the heating device based on the environmental humidity, and thereby the recording medium is dried which had been humidified by the environmental humidity, that is, created is the condition under which the assured images can be recorded onto the recording medium, independent of the environmental humidity.

Structure 4

The ink jet recording apparatus of any one of structures 1-3, wherein the heating device is a non-contact heater which heats the recording medium from above, and is installed upstream of the recording head, with respect to the conveyance direction of the recording medium.

According to structure 4, after the recording medium is heated by the heat value which is set by the heater, based on either the environmental temperature or humidity, and when the recording medium enters a condition in which images can be assuredly recorded, ink droplets are jetted from the recording head. When the recording medium is relatively thick, it is possible to shorten the time to reach the desired temperature of the recording medium, because the surface of the recording medium is heated from above.

Structure 5

The ink jet recording apparatus of any one of structures 1-4, wherein the control section controls the heat value by changing an applied voltage or a pulse width of the applied voltage onto the heating device.

According to structure 5, since the heating device heats the recording medium, with nearly constant heat value for target temperature, by changing the applied voltage or the pulse width of the applied voltage, based on at least the environmental temperature or humidity, created is the condition under which the assured images can be recorded onto the recording medium, independent of the environment.

Structure 6

The ink jet recording apparatus of any one of structures 1-5, wherein the control section controls the heat value, by changing the distance between the recording medium and the heating device.

According to structure 6, since the heating device heats the recording medium with the heat value which has been adjusted by changing the distance between the recording medium and the heating device, based on at least the environmental temperature or the environmental humidity, created is the condition under which the assured images can be recorded onto the recording medium, independent of the environment. Further, when the target temperature for the recording medium is changed, the temperature of the recording medium can be controlled without waiting for the temperature change of the heating device.

Structure 7

The ink jet recording apparatus of any one of structures 1-6, wherein the ink is an ultraviolet curing type which is hardened by ultraviolet-ray radiation, and wherein the light radiating device is a device which radiates ultraviolet rays.

According to structure 7, since the heating device heats the recording medium with the controlled heat value, based on at least the environmental temperature or humidity, created is the condition under which the ultraviolet curing type ink droplets, jetted onto the recording medium, can be assuredly hardened by the radiation of ultraviolet rays, independent of the environment.

Structure 8

The ink jet recording apparatus of any one of structures 1-7, wherein the ink is a cation curing type ink.

According to structure 8, since the heating device heats the recording medium with the controlled heat value based on at least the environmental temperature or humidity, created is the condition under which the cation curing type ink droplets jetted onto the recording medium can be assuredly hardened on the recording medium, independent of the environment.

### BRIEF DESCRIPTION OF THE DRAWINGS

FIG. 1(A) is a front view of an embodiment of the ink jet recording apparatus of the present invention.

FIG. 1(B) is a side view of an embodiment of the ink jet recording apparatus of the present invention.

FIG. 2 is a block diagram showing the structure of an embodiment of the ink jet recording apparatus of the present invention.

### DETAILED DESCRIPTION OF THE PREFERRED EMBODIMENT

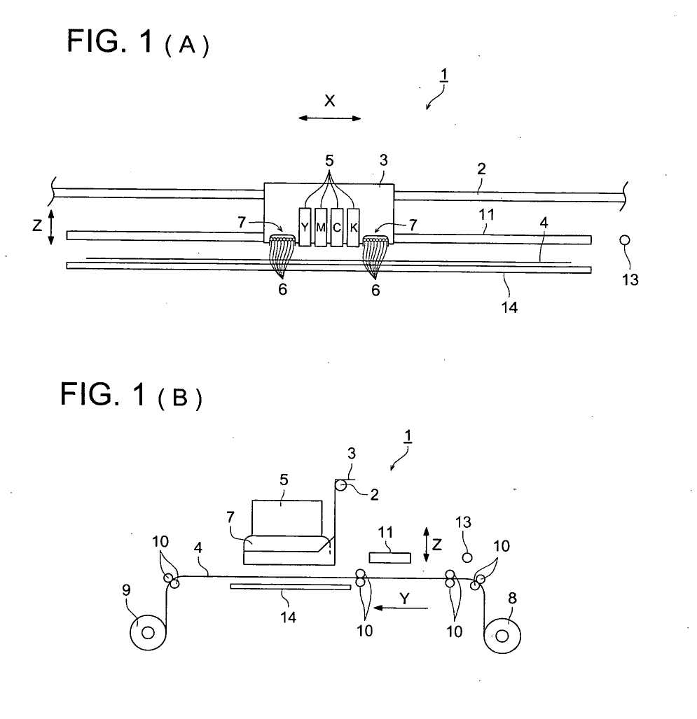

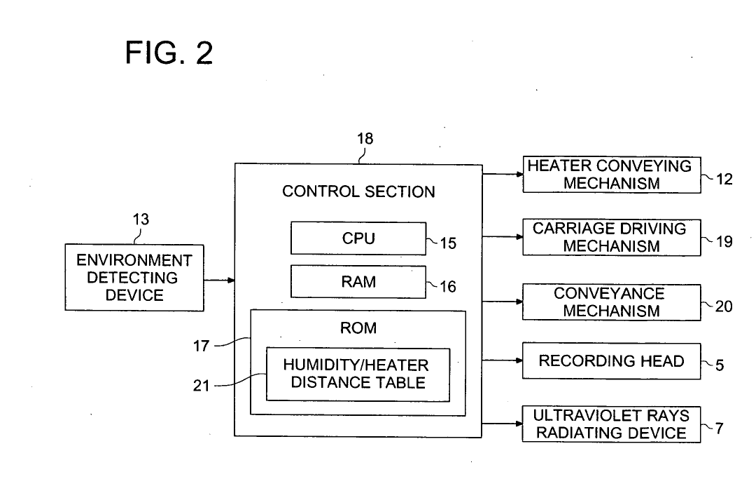

The embodiment of the present invention will be detailed, while referring to FIGS. 1(A), 1(B) and 2.

FIGS. 1(A) and 1(B) show the embodiment of ink jet recording apparatus 1 of the present invention, employing a serial head method. AS shown in FIG. 1(A), ink jet recording apparatus 1 features long cylindrical guide rail 2, on which carriage 3 is supported. Carriage 3 can be moved back and forth along guide rail 2 in scanning direction X by carriage moving mechanism 19 (see FIG. 2).

Recording head 5 is mounted on carriage 3 and features nozzles (which are not illustrated) for jetting ink droplets of yellow (Y), magenta (M), cyan (C) and black (BK) onto recording medium 4.

The ink used in the present embodiment is an ultraviolet curing type which is to be hardened by ultraviolet-ray radiation. Ultraviolet ray curing type ink is broadly classified into radical polymerizable type ink, including a radical polymerizable compound as a polymerizable compound, and cation polymerizable type ink, including a cation polymerizable type compound. Both types of ink are applicable as ink used in the present embodiment. Further, hybrid type ink wherein the radical polymerizable type ink and the cation polymerizable type ink are compounded is also applicable in the present embodiment. However, the cation polymerizable ink is hardly inhibited by the polymerization reaction of oxygen, and therefore the cation polymerizable type is superior in functionality and versatility, and which is more preferable in use.

Concerning recording medium 4, applicable are sheets such as plain paper, recycled paper and glossy paper, woven cloth, non-woven cloth, resin, metal, and glass. Specifically, for recording medium 4, applicable is a non-absorption transparent or non-transparent resin film used for so-called soft packaging.

On both sides of carriage 3 with respect to scanning direction X of recording head 5, ultraviolet-ray radiating device 7 is provided, featuring ultraviolet-ray radiating device 7 which has light source 6 and radiates ultraviolet-ray onto the ink droplets jetted onto recording medium 4 from the nozzle. For light source 6, applicable are a high pressure mercury lamp, a metal halide lamp, a hot cathode lamp, a cathode ray tube, and LED.

In ink jet recording apparatus 1, conveyance mechanism 20 (see FIG. 2) is provided, including feed out roller 8 for feeding out strips of recording medium 4 downward recording head 5, and take-up roller 9 for taking up recording medium 4 on which images have been recorded, wherein plural paired conveyance rollers 10 are arranged between feed-out roller 8 and take-up roller 9, and whereby convey recording medium 4 is conveyed in direction Y perpendicular to scanning direction X. While printing the images, conveyance mechanism 20 intermittently conveys recording medium 4, repeating conveyance and stopping of recording medium 4, all being synchronized with movement of carriage 3.

Upstream of recording head 5, with respect to conveyance direction Y of recording medium 4, non-contact type heater 11 is provided across the entire width of recording medium 4, above the recording surface of recording medium 4. Heater 11 is movable by heater conveying mechanism 12 (see FIG. 2) in direction Z vertical to the recording surface of recording medium 4.

Further, ambient environment detecting device 13 for detecting the environmental humidity around recording sheet 4 is provided above the recording surface of recording medium 4, upstream of heater 11 with respect to conveyance direction Y of recording medium 4.

A central section where carriage 3 can move is the recording area for recording onto medium 4, and in this recording area, provided is platen 14 which is structured of a flat member and supports recording medium 4 from a non-recording surface.

FIG. 2 shows a control device for controlling image recording apparatus 1 of the present embodiment. This control device is structured of CPU 15, RAM 16 and ROM 17, and further, integrates control section 18 which develops a process program recorded in ROM 17 onto RAM 16 and performs the process program via CPU 15.

Control section 18 controls the movements of each member, in accordance with the process program, and based on status of the movement conditions of carriage driving mechanism 19, conveyance mechanism 20, recording head 5, ultraviolet radiating device 7 and heater conveying mechanism 12.

Specifically, on ink jet recording apparatus 1, control section 18 is connected to ambient environment detecting device 13, and controls the heat value for heating recording medium 4 via heater 11, in accordance with the detected result of ambient environment detecting device 13.

To be more precise, table 21 shows the relationship between humidity and distance between heater 11 and recording medium 4 (hereinafter referred to as “humidity-distance table 21”) and was determined by the experiment, based on environmental humidity and is stored in ROM 17. Humidity-distance table 21 is proposed in such a way that in the case of each ambient environment humidity reading, experimentally obtained is the temperature at which recording medium 4 is heated and moisture in recording medium 4 is dried to the level where recording medium 4 produces an image having a predetermined quality, and next, experimentally obtained is the distance between heater 11 and recording medium 4 so that recording medium 4 is heated to the above obtained temperature, while conveyed under heater 11. The relationship between humidity and distance between heater 11 and recording medium 4 is shown in Table 21, (in this case, absorbent material was used for recording medium 4).

TABLE 21
humidity - distance table
(recording medium 4: being an absorbent material)

| Environmental | Distance between heater and |
|---|---|
| humidity (%) | recording medium (mm) |
| 20 | 40 (basic distance) |
| 40 | 30 |
| 60 | 20 |
| 80 | 10 |

In this experiment, the inventor established the basic distance between heater 11 and recording medium 4 to 40 mm, and environmental humidity to 20%, incidentally 20% humidity is the threshold value.

Further, when recording medium 4 is not an absorbent material, the inventor obtained ink hardness characteristics based on the thermal change and humidity change by the experimentation. Table 21a shows the relationship between humidity and distance between heater 11 and recording medium 4 (in this case, the ink is not absorbed by recording medium 4 since it is a non-absorbent material, but the ink is adhered onto the surface of recording medium 4).

TABLE 21A
humidity - distance table
(recording medium 4: being a non-absorbent material)

| Environmental | Distance between heater |
|---|---|
| humidity (%) | and recording medium (mm) |
| 20 | 40 (basic distance) |
| 40 | 36 |
| 60 | 28 |
| 80 | 19 |

Tables 21 and 21a are stored in ROM 17, and control section 18 uses either Table 21 or 21a, based on the employed recording medium.

Further, when the detected result of the environmental humidity by ambient environment detecting device 13 is inputted to control section 18, control section 18 selects the appropriate distance between heater 11 and recording medium 4 which corresponds to the detected environment humidity, based on humidity-distance table 21. Then control section 18 controls heater conveying mechanism 12, based on the selected distance between heater 11 and recording medium 4.

Next, the printing function of the present embodiment will be explained.

When image information is sent to ink jet recording apparatus 1, the environmental humidity detected by ambient environment detecting device 13 is inputted into control section 18. Then the distance between heater 11 and recording medium 4 corresponding to the detected environment humidity is selected by control section 18. Based on the selected distance between heater 11 and recording medium 4, heater conveying mechanism 12 places heater 11 at the predetermined distance from recording medium 4.

Under this condition, conveyance mechanism 20 is activated by control section 18, and recording medium 4 is conveyed in direction Y, and passes under heater 11. The recording surface of recording medium 4 is then heated by the predetermined heat value so that any moisture on the recording medium 4 is evaporated, and recording medium 4 can carry a practical image.

When recording medium 4 is conveyed under carriage 3, carriage driving mechanism 19 is activated by control section 18 to drive carriage 3 back and forth in scanning direction X, and further, the predetermined color ink droplets are jetted from the nozzles of recording head 5 in accordance with prescribed image information. The jetted ink droplets are sequentially deposited onto recording medium 4. While carriage 3 is driven, ultraviolet rays are radiated from ultraviolet radiating device 7 onto the ink droplets deposited on recording medium 4 whereby the ink droplets are hardened. During the above mentioned operation, conveyance mechanism 20 conveys recording medium 4 in conveyance direction Y so that the desired image is recorded onto recording medium 4.

That is, the ink droplets are deposited onto recording medium 4 which has come into the condition suitable for recording the assured image, the predetermined diameter ink droplets are hardened by the ultraviolet rays, and thereby the ink droplets are assuredly hardened.

As previously mentioned, according to ink jet recording apparatus 1 relating to the present embodiment, recording medium 4 is heated based on the environmental temperature, after which any moisture on recording medium due to environmental humidity is dried, and recording medium 4 is brought to a preferable condition for hardening the ultraviolet curing ink droplets deposited onto recording medium 4. Therefore, it is possible to uniformly obtain the practical images, independent of environmental conditions.

In the present embodiment, the distance between heater 11 and recording medium 4 is changed based on the environmental humidity so that the heat value emitted from heater 11 to recording medium 4 is changed, however, the method for adjusting the heat value is not limited to the above description. For example, it is also possible to change the applied voltage to heater 11 or the pulse width of the applied voltage to the heater. Still further, it is possible to form platen 14 of a heat plate so that platen 14 functions as the heating device, instead of heater 11.

For the heating device instead of radiant heater 11, a hot air device which blows hot air, can also be used.

The amount of heat from heater 11 onto recording medium 4 is adjusted based on the environmental humidity in the present embodiment, however, it is also allowable to adjust the heat based on the environmental temperature.

Still further in the present embodiment, recording head 5 being a serial head method, is employed, however, also employable is an in-line recording head method, which is arranged above the recording medium across the total width of the recording medium, and thereby jets the essential ink droplets onto the conveying recording medium. In such case, it is possible to provide a vertically movable heater, above the recording medium, upstream of the recording head with respect to the conveyance direction, and across the total width of the recording medium. This would also allow provision of an environment detecting device for detecting ambient humidity in the vicinity of the recording medium, above the recording medium and upstream of the heater with respect to the conveyance direction of the recording medium.

Still further, an ultraviolet-ray hardenable ink is used in the present embodiment, however the ink is not limited to this. Ink which is hardened by other types of light rays can also be used. The above mentioned “light rays” are light rays in the broad sense of the term, which include electromagnetic waves such as electron rays, X-rays, visible light rays and infrared rays, as well as ultraviolet rays. That is, a polymerizable compound which is polymerized and hardened by the light rays other than ultraviolet rays, as well as a photoinitiator which starts a polymerization reaction between each of the polymerization compounds by light rays, other than ultraviolet rays, can be applied for the ink. When the light curing ink which is hardened by the light rays except ultraviolet rays is used, an appropriate light source, for radiating the desired light rays, is applied instead of light source 6 for radiating ultraviolet rays.

In regard to the effects of the present invention, based on the invention described in structure 1, since the recording medium is heated by the heating device at an amount of heat which is controlled based on the ambient environmental condition, and further the recording medium is brought to a condition which is suitable for printing the practical images, it is possible to obtain uniform and practical images, independent of the environmental condition.

Based on the invention described in structure 2, when the results measured by the environment detecting device surpasses the predetermined threshold level, the recording medium is heated by the heating device, bringing the recording medium into an optimal condition for recording the images, and thereby it is possible to obtain uniform and practical images, independent of environmental conditions.

Based on structure 3, the recording medium is heated by the heating device based on ambient environmental humidity, and thereby the recording medium carrying moisture due to environmental humidity is dried, bringing the recording medium to a condition which is suitable for recording the images, making it possible to obtain uniform and practical images, independent of environmental conditions.

Based on structure 4, after the recording medium is heated by the heater with the heat value which is set by the heater, based on either environmental temperature or humidity, and when the recording medium is brought to a condition in which practical images can be recorded, ink droplets are jetted onto the recording medium from the recording head, whereby it is possible to obtain uniform and practical images, independent of the environmental conditions. If the recording medium is relatively thick, it is possible to shorten the time for the recording medium to reach the predetermined temperature, because the recording surface of the recording medium is heated from above.

Based on structure 5, since the heating device heats the recording medium, at nearly constant heat value to target temperature, by changing the applied voltage or the pulse width of the applied voltage, based on either the environmental temperature or humidity, the recording medium is brought to a condition under which practical images are recorded, and accordingly it is possible to obtain uniform and practical images, independent of environmental conditions.

Based on structure 6, since the heating device heats the recording medium with the heat value, obtained by changing the distance between the recording medium and the heating device, based on either environmental temperature or humidity, the recording medium is brought to a condition under which practical images are recorded, independent of the environment. Thus, it is possible to obtain uniform and practical images, independent of the environmental condition. Further, when the target temperature of the recording medium is changed, the temperature of the recording medium can be controlled without waiting for the temperature to change from the heating device.

Based on structure 7, since the heating device heats the recording medium, at a controlled amount of heat based on either environmental temperature or humidity, the recording medium is brought to a condition under which the ink droplets of the ultraviolet curing type jetted onto the recording medium are assuredly hardened by the radiation of ultraviolet rays, independent of the environment. Accordingly it is possible to obtain uniform and practical images, independent of environmental conditions.

Based on structure 8, in which the heating device heats the recording medium, with a controlled amount of heat based on either environmental temperature or humidity, the recording medium is brought to a condition under which the ink droplets of the cation curing type jetted onto the recording medium can be hardened, independent of environment. Accordingly it is possible to obtain uniform and practical images, independent of environmental conditions.

What is claimed is:

1. An ink jet recording apparatus, comprising:
a recording head for jetting ink droplets onto a recording medium;
a light radiating device for radiating light rays to harden the ink droplets adhered onto the recording medium;
a heating device for emitting heat to heat the recording medium;
an environment detecting device for detecting at least any one of environmental temperature or environmental humidity; and
a control section for controlling an amount of heat emitted from the heating device, based on a detected result of the environment detecting device.

2. The ink jet recording apparatus in claim 1,
wherein the environment detecting device detects environmental humidity, and when a detected result by the environment detecting device surpasses a threshold level, the control section controls the heating device to heat the recording medium.

3. The ink jet recording apparatus in claim 1, wherein the environment detecting device detects the environmental humidity, and the higher the humidity detected by the environment detecting device becomes, the higher the control section sets the amount of heat to be generated by the heating device.

4. The ink jet recording apparatus in claim 1, wherein the heating device is a non-contact heater which heats the recording medium from above, and is installed upstream of the recording head, with respect to a conveyance direction of the recording medium.

5. The ink jet recording apparatus in claim 1, wherein the control section controls the amount of heat by changing an applied voltage or an impressed time of the applied voltage onto the heating device.

6. The ink jet recording apparatus in claim 1, wherein the control section controls the heat value, by changing a distance between the recording medium and the heating device.

7. The ink jet recording apparatus in claim 1, wherein the ink is an ultraviolet curing type which is hardened by the radiation of the ultraviolet rays, and wherein the light radiating device is an ultraviolet radiating device which radiates the ultraviolet rays.

8. The ink jet recording apparatus in claim 1, wherein the ink is cation curing type ink.
